(19) United States
(12) Patent Application Publication
(10) Pub. No.: US 2003/0014838 A1
(43) Pub. Date: Jan. 23, 2003

(54) Three knuckle hinge with bushing inserts

(76) Inventors: Egidio L. deOliveira, High Point, NC (US); Earl D. Forrest, Asheboro, NC (US)

Correspondence Address: Edgar A. Zarins, Masco Corporation, 21001 Van Born Road, Taylor, MI, 48180, US

(21) Appl. No.: 10/021,209

(22) Filed: Oct. 30, 2001

Related U.S. Application Data
(60) Provisional application No. 60/307,079, filed on Jul. 20, 2001.

(51) Int. Cl. E05D 11/00

(52) U.S. Cl. 16/233

(57) ABSTRACT

A two piece hinge with cooperating hinge knuckles to pivotably join the hinge pieces. One of the hinge members includes a center tubular knuckle and the other of the hinge members has a pair of tubular knuckles spaced apart to receive the center knuckle of the first hinge member. Tubular sleeves or bushings are positioned within each of the knuckles and a hinge pin is inserted through all the knuckles to correct the hinge members. Washers are inserted between the knuckles to prevent contact and end caps are secured to the hinge pin to maintain assembly of the hinge. The bushing inserts and washers are made of an anti-friction material to minimize wear on the hinge.

### RELATED APPLICATIONS

This application claims priority from U.S. Provisional Application No. 60/307,079 filed on Jul. 20, 2001.

### BACKGROUND OF THE INVENTION

I. Field of the Invention

This invention relates to hinges for pivotably connecting a first member, such as a door, to a second member, such as a cabinet housing to facilitate movement of the door relative to the cabinet and, in particular, to a three knuckle hinge having mating hinge knuckles and inserts for reducing frictional wear between the components of the hinge members.

II. Description of the Prior Art

Hinges are useful for connecting a first member to a second member where it is desirable to pivotably move the first member relative to the second. An example is a door pivotably mounted to a fixed cabinet. A common side of the door and cabinet will each have portions of the hinges secured thereto using fasteners such that the common edge will be maintained in close proximity as the door pivots between open and closed positions.

A common type of hinge is the three knuckle hinge where one of the hinge members includes a pair of spaced apart tubular knuckles and the other hinge member includes a single tubular knuckle received between the knuckles of the other hinge member. A hinge pin extends through the knuckles to prevent separation. However, friction between the hinge pin and the knuckles and even the edges of the knuckles as they contact the adjacent knuckle creates wear which can lead to failure of the hinge requiring replacement.

### SUMMARY OF THE PRESENT INVENTION

The present invention overcomes the disadvantages of the prior known hinges by providing low friction inserts and washers to separate the metal components thereby reducing friction and wear of the components.

The three knuckle hinge of the present invention includes a pair of cooperating hinge members each having a planar leaf capable of being fastened to a respective cabinet component. A first hinge member includes a pair of spaced apart knuckles having a tubular configuration extending from the leaf portion thereof. A second hinge member has a single knuckle with a tubular configuration extending from the planar leaf portion thereof. Upon assembly of the hinge members, the single knuckle of the second hinge member will fit between the pair of knuckles of the first hinge member thereby aligning the bores of the knuckles.

Prior to assembly, anti-friction bushings are inserted into each of the two outer knuckles. Disposed between each of the bushings and knuckles are anti-friction flat washers to minimize friction between the moving center knuckle and the stationary outer knuckles. A hinge pin is inserted through the aligned bushings disposed within the knuckles to connect the hinge members while allowing relative movement. In one embodiment, the center knuckle has a reduced inner diameter or a metal sleeve is used to prevent rotation of the hinge pin within the center knuckles. The center knuckle does not receive an anti-friction bushing since the hinge will perform better and last longer if it is forced to pivot on the two outer knuckles and bushings The center knuckle may be fixedly press fitted or pinned to the hinge pin. The outer knuckles will rotate about the hinge pin. To prevent longitudinal movement of the hinge pin while also adding a decorative element to the hinge, end caps are positioned within the outer ends of the hinge. In a preferred embodiment, the end caps include pins received within end bores of the hinge pins. The anti-friction bushings and washers reduce wear on the components of the hinge by eliminating metal to metal contact between the components.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is a plan view of an assembled three knuckle hinge embodying the present invention; and

FIG. 2 is an exploded view of the hinge.

### DETAILED DESCRIPTION OF A PREFERRED EMBODIMENT OF THE PRESENT INVENTION

Referring to the drawing, there is shown a hinge assembly 10 of the type used to control the pivoting movement of a door relative to a cabinet or housing. Typically, the hinges 10 will be used in multiples to provide stability and strengthen as the door moves between its open and closed positions. The hinges 10 are secured to a common edge of the door and the housing so as to pivot at the common edge. Depending upon the material composition of the door and housing, typical fasteners are used to attach the hinges to the edge of the cabinet. While the present invention will be described in connection with a cabinet door hingedly connected to a cabinet, it is to be understood that the three knuckle hinge 10 of the present invention can be used with a variety of pivoting devices such as gates and larger doors.

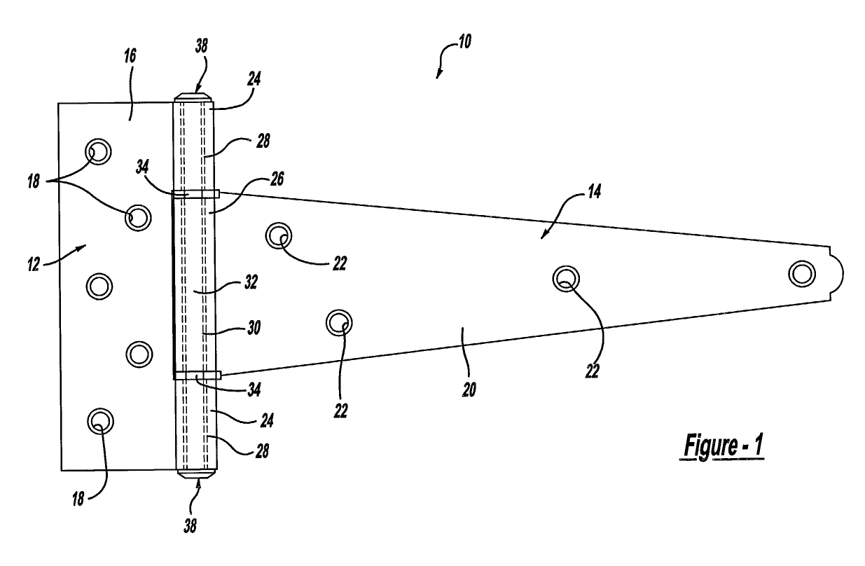

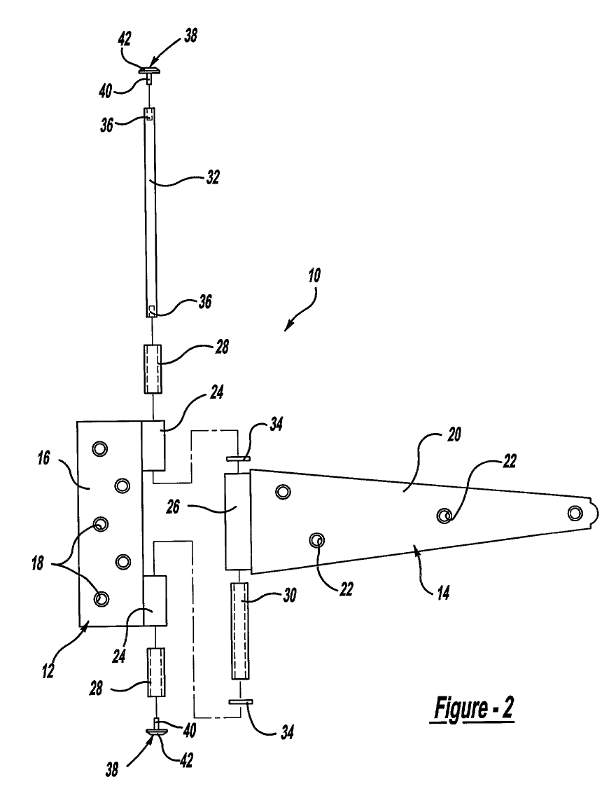

Referring to FIGS. 1 and 2, the hinge assembly 10 includes a pair of major components pivotably joined to create the hinging movement. However, anti-friction components are included to reduce wear of these major components and thereby improve operation of the hinge 10. The hinge assembly 10 includes a first hinge member 12 pivotably joined to a second hinge member 14. The first hinge member 12 includes a planar leaf portion 16 having a plurality of apertures 18 through which fasteners are fed to secure the first leaf portion 16 to the door or cabinet. Similarly, the second hinge member 14 includes a planar leaf portion 20 having a plurality of apertures 22 for fasteners. The drawings depict representative configurations for the leaf portions 16,20 and it is to be understood that these planar members may be any convenient configuration.

Formed along one edge of the first hinge member 12 is a pair of spaced apart tubular knuckles 24. These knuckles 24 may be formed by rolling a portion of the planar leaf 16 to create aligned tubes 24. Alternatively, the tubular knuckles 24 may be attached to the planar leaf 16.

The second hinge member 14 includes a single tubular knuckle 26 formed along one edge thereof. Similarly, the knuckle 26 may be rolled of the edge of the planar leaf 20 or attached to the leaf member 20. The tubular knuckle 26 is sized to fit between the spaced apart knuckles 24 of the first hinge member 12.

Tubular bushings 28 formed of an anti-friction material are disposed within the spaced knuckles 24. A tubular bushing 30 formed of an anti-friction material may also be used in the center knuckle 26 although it is contemplated that a metal bushing may be used in the center knuckle 26 or otherwise fix the center knuckle 26 to the hinge pin 32. The anti-friction bushings are designed to reduce wear between the inner surface of the knuckles and a hinge pin 32 which extends through all three knuckles 24,26 to pivotably join the first and second hinge members 12,14. Disposed between the adjacent knuckles 24,26 are thin washers 34 also formed of an anti-friction material.

The hinge pin 32 includes partial axial bores 36 in each end for receiving end caps 38. The end caps 38 include a pin 40 configured to be received in the axial bore 36 and a cap portion 42 configured to conceal the outer end of the tubular knuckles 24 and provide an aesthetically appealing appearance. The end caps 38 also prevent the hinge pin 32 and bushings 28 from shifting within the knuckles 24,26.

Thus, the inserted bushings and the flat washers reduce wear between moving parts thereby increasing the resisting movement arm, load capacity and useful life of the hinge 10 The hinge assembly 10 performs optimally when it pivots on the two outer knuckles 24 and is fixedly secured to the hinge pin 32 along the center knuckle 32.

The foregoing detailed description has been given for clearness of understanding only and no unnecessary limitations should be understood therefrom as some modifications will be obvious to those skilled in the art without depending from the scope and spirit of the appended claims.

What is claimed is:

1. A hinge assembly comprising:
a first hinge member having a leaf portion and a pair of spaced apart tubular knuckles;
a second hinge member having a leaf portion and a center tubular knuckle, said center tubular knuckle disposed between said spaced apart tubular knuckles of said front hinge member;
bushing inserts disposed within said spaced apart knuckles of said first hinge member; and
a hinge pin extending through said spaced apart tubular knuckles and said center tubular knuckle to pivotably connect said first and second hinge members.

2. The hinge assembly as defined in claim 1 wherein said bushing inserts are formed of an anti-friction material to reduce wear between said hinge pin and said spaced apart tubular knuckles.

3. The hinge assembly as defined in claim 2 wherein said center tubular knuckle of said second hinge member is fixedly attached to said hinge pin.

4. The hinge assembly as defined in claim 2 and further comprising bearing washers disposed between said center tubular knuckle and said spaced apart tubular knuckles of said first hinge member, said hinge pin extending through an aperture of said bearing washers.

5. The hinge assembly as defined in claim 4 wherein said hinge pin receives end caps configured to conceal the outer ends of said spaced apart knuckles of said first hinge member.

6. The hinge assembly as defined in claim 5 wherein said hinge pin includes partial axial bores and said end caps include a pin member received within said partial axial bore.
